(19) United States
(12) Patent Application Publication
(10) Pub. No.: US 2004/0148417 A1
(43) Pub. Date: Jul. 29, 2004

(54) Method and system for distinguishing higher layer protocols of the internet traffic

(76) Inventors: Byeong-Hee Roh, Seoul (KR); Seung-Wha Yoo, Seoul (KR); Hyo-Gon Kim, Seoul (KR)

Correspondence Address: CANTOR COLBURN, LLP, 55 GRIFFIN ROAD SOUTH, BLOOMFIELD, CT, 06002

(21) Appl. No.: 10/451,085

(22) PCT Filed: Jun. 19, 2001
(86) PCT No.: PCT/KR01/01043

(30) Foreign Application Priority Data
Dec. 19, 2000 (KR) 2000/78637

(51) Int. Cl. G06F 15/16

(52) U.S. Cl. 709/230

(57) ABSTRACT

The present invention relates to a method and system for distinguishing higher layer protocols of the Internet traffic. The method comprises the steps of abstracting basic data from an arrival packet, determining whether or not the abstracted basic data exists in a predetermined administration table, registering a target protocol by selecting the target protocol in corresponding with a higher layer protocol of the arrival packet from a plurality of predetermined target protocols when the abstracted basic data don't exist in the predetermined administration table, renewing the administration table in accordance with the abstracted basic data when the abstracted basic data exists in the predetermined administration table.

### TECHNICAL FIELD

The present invention relates to a method and system for distinguishing protocols higher than the transport layer by the use of traffic transmitted via the Internet.

### BACKGROUND ART

The conventional method for distinguishing IP (Internet Protocol) and other protocols will be described with accompanying detailed drawings.

FIG. 1 shows a model illustrating the TCP/IP layers and identifying the representative protocols used at each layer.

Referring to FIG. 1, the TCP/IP layer model can be divided into 4 layers, which are the data link layer 101, the network layer 103, the transport layer 105 and the higher layer 107. The data link layer 101 executes physical data transmission on a network and can utilize ETHERNET, TOKEN BUS, TOKEN RING and FIBER DISTRIBUTED DATA INTERFACE (FDDI) for data transmission. The network layer 103 utilizes IP for data transmission. The transport layer 105 utilizes TCP (Transmission Control Protocol) 115 or UDP (User Datagram Protocol) 117. The higher layer 107 utilizes various application services such as TELNET, FTP (File Transfer Protocol), SMTP (Simple Mail Transfer; Protocol) and DNS (Domain Name Server).

FIG. 2 illustrates an encapsulating process in the TCP/IP layer model for transmitting a user's data via the Internet.

Referring to FIG. 2, data 209 to be transmitted via the Internet is combined with a higher-layer header 207 and as a result, higher-layer protocol data is produced in the higher layer. The higher-layer protocol data is combined with a transport-layer header 205 and as a result, transport-layer protocol data is produced in the transport layer. The transport-layer protocol data is combined with an IP header 203 and as a result, an IP datagram is produced in the network layer. The IP datagram is combined with a data-link-layer header 201 and/or a data-ink-layer tail and as a result, a data-link-layer frame is produced. The data-link-layer frame is transmitted to other networks via the physical medium. The network that receives the data-link-layer frame executes the aforementioned process in reverse order to extract the data 209.

FIG. 3 shows the general structure of an IP datagram, which is the standard for data transmission via the Internet.

Referring to FIG. 3, an Internet packet is comprised of higher-layer data 301, a higher-layer protocol data header 303, a transport-layer protocol data header 305 and an IP-layer datagram header 307. The IP-layer datagram header 307 is generally comprised of a PROTOCOL field, a SRC ADDR (source address) field, a DEST ADDR (destination address) field and an IDENTIFICATION field. In this case, the SRC ADDR indicates the IP address of the source and the DEST ADDR indicates the IP address of the destination.

In a case wherein UDP is utilized, the transport-layer protocol data header 305 is comprised of a SRC PORT (source port) field, a DEST PORT (destination port) field, a message length field and checksum field. In a case wherein TCP is utilized, the transport-layer protocol data header 305 is further comprised of a SEQ NO (sequence number) field, and an ACK NO (acknowledgement number) field.

Depending on the protocol used in the higher layer, the higher-layer protocol data header 303 can be comprised of different fields. In the case of an RTP (real-time transport protocol), for example, the higher-layer protocol data header 303 is comprised of a VER (version) field, a PTYPE (payload type) field, a SEQ NO (sequence number) field and a TIME STAMP field.

A plurality of conventional monitoring methods used to capture and classify internet traffic by using protocols for the purpose of managing the Internet are focused on the IP layer or the transport layer of TCP/UDP stack in a TCP/IP layer model. According to a specification in RCF 791 of IETF (Internet Engineering Task Force), IP datagram 307 is comprised of a PROTOCOL field, so different protocols of the IP layer and the transport layer can be classified on the basis of the PROTOCOL field.

TCP and UDP at the transport layer are prescribed respectively in RFC 793 and RFC 768 of IETF. As aforementioned, the transport-layer protocol data header 305 of the TCP and UDP stack at the transport layer is comprised of an SRC PORT field and a DEST PORT field. Each end node connects application programs or application protocols at the higher layer by the use of port information and IP addresses.

IETF regulates that port fields of transport-layer protocol data headers 305 utilize a well-known port, which is a higher-layer protocol and a frequently or commonly used port. That is, in the case of using a well-known port, higher-layer protocols can be distinguished only by the number in the port field of TCP or UDP header.

FIG. 4 shows representational well-known ports.

Referring to FIG. 4, in the case of FIT, port 20, port 21, port 23, port 35 and port 53 are assigned to data, control, telnet, SMTP and DNS respectively. So, for example, if the port number is 23, then it is obvious that the application protocol of the higher layer is TELNET.

Other protocols that do not utilize a well-known port, do however, have an arbitrary number in their protocol fields. In this case, it is difficult to find out what protocol is used in the higher layer of an IP datagram 307 only or a transport-layer protocol data header 305 only.

Up to now, most application programs that utilize the Internet do so for the purpose of transmitting characters or files. Presently, however, various applications such as Internet phoning, Internet broadcasting, video chatting, video conferencing and network gaming are being used more often by the general public. Conventional data applications for text and multimedia purposes comprising video and voice are fundamentally different in the characteristics of their traffic generation and quality requirements. The data traffic of conventional data applications based on text have an interval of packet generation, length of packet, and quality requirement that varies, so that even if there is some delay, no packet loss is permitted. On the contrary, multimedia traffic has more complicated patterns of traffic generation and different quality requirements from those of data traffic. Especially, a packet of voice data has a fixed length and is generated in fixed intervals, but a packet of video traffic may be fixed or unfixed in length. The service quality of this multimedia traffic depends on delays and variation of delay with some packet loss permitted.

Accordingly, in order to improve the service quality of multimedia applications including Internet phone, it is necessary to classify multimedia traffic by protocol or application according to the amount of network resources occupied and the degree of service required. Conventional methods and systems for managing a network or network traffic, however, have provided information on a coefficient of the utilization or transmission quality of network resources on the assumption that all traffic on the Internet is data traffic. This problem arose from that conventional methods and systems for managing networks or traffic could only distinguish a few higher-layer protocols related to data applications that use well-known ports and could not distinguish the higher-layer protocols of multimedia traffic such as RTP (real-time transport protocol).

### DISCLOSURE OF THE INVENTION

Accordingly, it is an object of the present invention to provide a method and device for effectively distinguishing the higher layer protocols of internet traffic, which protocols can not be distinguished by means of the information in IP-layer headers or transport-layer headers.

It is another object of the present invention to provide a method and device for providing a basic means for producing statistical data on the shared percentage of Internet resources, and the traffic characteristics of application-layer protocols by distinguishing these protocols, so that internet management systems or traffic management systems can effectively manage that portion of the traffic having higher quality requirements.

It is yet still another object of the present invention to provide a method and device for distinguishing the higher-layer protocols of Internet traffic, which method and device can extract application-layer protocols from internet traffic related to each service requiring special quality services, for example, Internet phone or Internet broadcasting, and then provide a scheme to improve these services.

Yet still another object of the present invention is to provide a method and device for distinguishing the higher-layer protocols of Internet traffic, which method and device can improve the accuracy of the classification of the higher-layer protocols and reduce the time required to classify these protocols.

Another object of the present invention is to provide a method and device for distinguishing the higher-layer protocols of Internet traffic, which method and device can improve the accuracy of the classification of the higher-layer protocols and reduce the time required to classify these protocols, by maintaining a state wherein the basic data during the internet connection is reserved, thus enabling detailed classification requiring a fair amount of time and calculation in classification process of higher-layer protocols to be executed in the before-learning state, and then the brief classification using basic data to be executed in the after-learning state.

To achieve the above-mentioned objectives, according to one aspect of the preferred embodiment of the present invention, a method for distinguishing a higher-layer protocol in an arriving packet, wherein the higher layer is higher than the transport layer, the method comprising the steps of: abstracting the basic data from the arriving packet, determining whether or not the abstracted basic data exists in a predetermined administration table, abstracting a target protocol by selecting the target protocol corresponding to the higher-layer protocol of the arriving packet from a plurality of predetermined target protocols, and, in the event that the abstracted basic data doesn't exist in the predetermined administration table, registering the basic data and the abstracted target protocol at the predetermined administration table, and, in the event that the abstracted basic data does exist in the predetermined administration table, renewing the administration table corresponding to the abstracted basic data, and a device and method corresponding to the method can be provided.

In one preferred embodiment of the present invention, statistical data based on the classification of the plurality of arriving packets into each higher-layer protocol by the use of said steps can be utilized in a network management system to manage said network. Also, a MIB (Management Information Base) for the statistical data on each higher-layer protocol is additionally defined, or the statistical data on each higher-layer protocol is composed of a predetermined form. Herein the higher-layer protocol is at least one selected from a group consisting of RTP, RTCP and a nonstandard internet phone protocol from each provider, and is utilized for distinguishing the traffic of Internet phone and the traffic of non-internet phone in order to obtain the necessary statistical data. The statistical data on the traffic of Internet phone and the traffic of non-internet phone are represented as at least one selected from a group consisting of time, protocol, source IP address, destination IP address and a pair of source IP address and destination IP address. The statistical data on the traffic of Internet phone and the traffic of non-internet phone can be represented by graphics or text.

In another preferred embodiment of the present invention, the basic data is comprised of at least one field from a plurality of fields assigned to an IP datagram header or a transport-layer protocol header.

In still another preferred embodiment of the present invention, the plurality of the predetermined target protocols are a plurality of fields for detailed comparison, wherein the plurality of fields are selected and stored in advance.

In still another preferred embodiment of the present invention, the method can further comprise the step of classifying the protocol of the arriving packet as either reserved protocol or a protocol corresponding to a well-known port. Said classification step is utilized in the event that a reserved protocol is designated in a protocol field of the IP datagram header of the arriving packet, or a well-known port is designated in a protocol field of the transport-layer protocol data header of arriving packet.

In still another preferred embodiment of the present invention, the predetermined administration table is comprised of a basic data field for storing basic data, a protocol field for storing protocols, an additional data field for storing additional data, a time data field for storing time data, a state field for storing classification states, wherein the state is comprised of a before-learning state and an after-learning state, and a counter field that corresponds to the state field. Herein, the method can further comprise the step of registering the abstracted additional data in the predetermined administration table in the event that the additional data is required for the target protocol.

In still another preferred embodiment of the present invention, the step of abstracting the target protocol by selecting the target protocol corresponding to the higher-layer protocol of the arriving packet from a plurality of predetermined target protocols in the event that the abstracted basic data doesn't exist in the predetermined administration table, is the step of abstracting the target protocol when content stored in a predetermined field of the target protocol's header matches or consistently corresponds to content stored in a field of a higher-layer protocol data header on the corresponding arriving packet. Herein, the predetermined field may be all fields or a part of essential fields for distinguishing the target protocol. Herein, the step of renewing the administration table corresponding to the abstracted basic data in the event that the abstracted basic data exists in the predetermined administration table comprises the steps of: executing a detailed comparison in the event of the before-learning state, and executing a brief comparison in the event of the after-learning state The step of executing a detailed comparison in the event of a before-learning state comprises the steps of: designating a protocol in the protocol field of the predetermined administration table as the target protocol, determining whether or not the higher-layer protocol data header of the arriving packet corresponds to the designated target protocol header, and if the arriving packet header does correspond then classifying the arriving packet using the designated target protocol, increasing a number in the counter field by 1 and then renewing the state to the after-learning state and the counter field to its initial value wherein the increased number is not less than a first positive integer N and deleting all fields corresponding to the basic data in the predetermined administration table in the event that said arriving packet header does not correspond to the designated target protocol header. Herein the step of determining whether or not the higher-layer protocol data header of the arriving packet corresponds to the designated target protocol header is the step of determining whether or not content stored in the predetermined field of the target protocol's header matches or consistently corresponds to content stored in a field of the higher-layer protocol data header of the corresponding arriving packet. The predetermined field may be all fields or a part of essential fields used for distinguishing the target protocol.

In still another preferred embodiment of the present invention, the step of executing a brief comparison in the event of an after-learning state comprises the steps of: determining whether or not the abstracted basic data corresponds to the basic data stored in the basic data field of the predetermined administration table, determining whether or not a number in the counter field corresponding to the abstracted basic data is less than a second positive integer M in the event of correspondence arising from the determination, classifying the arrival packet using the protocol designated in the protocol field of the predetermined administration table and then increasing the number in the counter field by 1 in the event that the number in the counter field is less than the second positive integer M according to the result of the determination, initializing the counter field in the event that the number in the counter field is not less than the second positive integer M according to the result of the determination, comparing in detail, initializing the counter field, and then executing an initial detailed comparison in the event of discordance arising from the determination.

In still another preferred embodiment of the present invention, the statistical data is at least one selected from a group consisting of a count of the arriving packets, a delay, a delay variation, a count of packet loss, the ratio of packet loss, a count of erred packets, the ratio of erred packets, and the ratio of transmission, wherein statistical data is produced from the arriving packet and from a plurality of previously-arrived packets having the same classified protocol corresponding to the arriving packet or a plurality of previously-arrived packets having the same basic data corresponding to the arriving packet and wherein the plurality of previously-arrived packets arrived earlier than the arriving packet. The statistical data is produced to relate to at least one selected from a group consisting of a source IP address, a destination IP address, a source port number, a destination port number and the protocol field.

To achieve the above-mentioned objectives, according to one aspect of the preferred embodiment of the present invention, a method for distinguishing one data type of a higher-layer, wherein the higher layer is higher than the transport layer, the method comprising the steps of: abstracting basic data from the arriving packet, determining whether or not the abstracted basic data exists in a predetermined administration table, in the event that the abstracted basic data doesn't exist in the predetermined administration table, abstracting a data type by selecting the target protocol corresponding to the higher-layer protocol of the arriving packet from a plurality of predetermined target protocols, wherein the data type is comprised of protocols and additional data, registering the basic data and the abstracted data type at the predetermined administration table and renewing the administration table corresponding to the abstracted basic data in the event that the abstracted basic data exists in the predetermined administration table, and a device and system corresponding to the method can be provided.

### BRIEF DESCRIPTION OF DRAWINGS

FIG. 1 shows a TCP/IP layer model used on the Internet and representative protocols used on each layer;

FIG. 2 illustrates an encapsulating process in the TCP/IP layer model for transmitting a user's data via the Internet;

FIG. 3 shows the general structure of an IP datagram, which is a standard for data transmission via the Internet;

FIG. 4 shows the numbers of representational well-known ports;

FIG. 5 illustrates the classification states of higher-layer protocols and the transition between each state in accordance with the preferred embodiment of the present invention;

FIG. 6 shows the administration table in accordance with the preferred embodiment of the present invention;

FIG. 7 is a flowchart illustrating the classification process of higher-layer protocols in accordance with the preferred embodiment of the present invention;

FIG. 8 is a flowchart illustrating the initial detailed comparison process of the higher-layer protocols of arrival packets in accordance with the preferred embodiment of the present invention;

FIG. 9 is a flowchart illustrating the detailed comparison process of the higher-layer protocols of arrival packets in accordance with the preferred embodiment of the present invention;

FIG. 10 is a flowchart illustrating the brief comparison-process used to determine the higher-layer protocols of arrival packets in accordance with the preferred embodiment of the present invention;

FIG. 11 is a flowchart illustrating the process used to abstract the statistical data on the traffic of Internet phone applications and the traffic of non-internet phone applications in accordance with the preferred embodiment of the present invention;

FIG. 12 shows the statistical characteristics acquired from the abstracting process in FIG. 11.

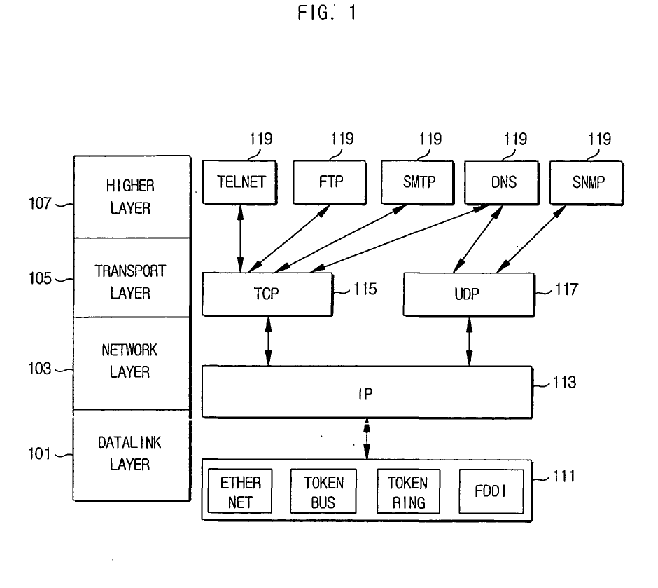

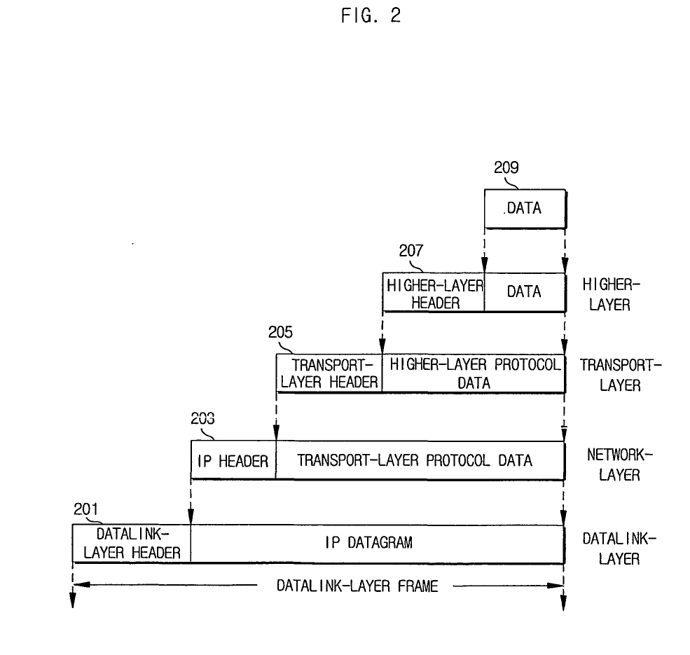

### THE DESCRIPTION OF THE REFERENCE CHARACTERS OF THE MAJOR PARTS OF THE DRAWINGS

| | |
|---|---|
| 301: higher-layer data | 303: higher-layer protocol data header |
| 305: transport-layer protocol | |
| data header | |
| 307: IP-layer datagram header | 501: before-learning state |
| 503: after-learning state | 505: comparison in detail |
| 601: basic data field | 603: state field |
| 605: counter field | 607: protocol field |
| 609: additional data field | 611: time data field |

### DETAILED DESCRIPTION OF THE PREFERRED EMBODIMENTS

Hereinafter, the preferred embodiment of the present invention will be described with accompanying drawings.

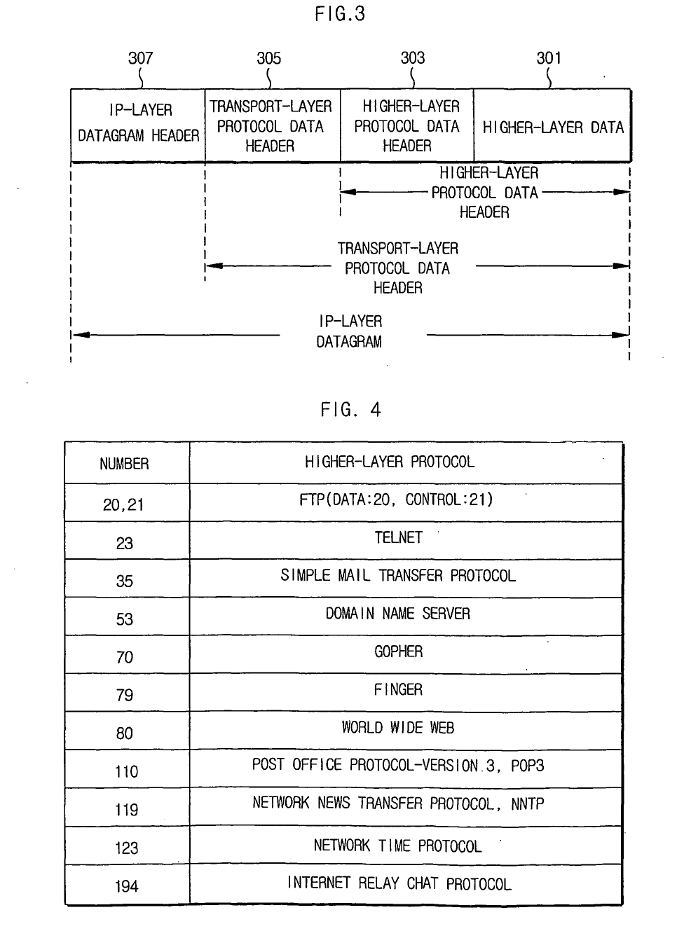

Referring again to FIG. 3, showing the data structure of a packet transmitted via the Internet, and identifying what protocols are related to the IP layer, for example routing protocols such as ICMP, IGMP, RIP and BGP, or what protocols are utilized at the transport layer, and the method by which said protocols can be determined by detecting the protocol field in the IP-layer datagram header 307. In the case of well-known ports, detecting a source port field or a destination field in the transport-layer protocol data header 305 can determine what protocol is utilized at the higher layer.

Herein higher-layer data 301 with a higher-layer protocol data header is higher-layer protocol data, higher-layer protocol data with a transport-layer protocol data header 305 is transport-layer protocol data and transport-layer protocol data with an IP-layer datagram header 307 is an IP datagram.

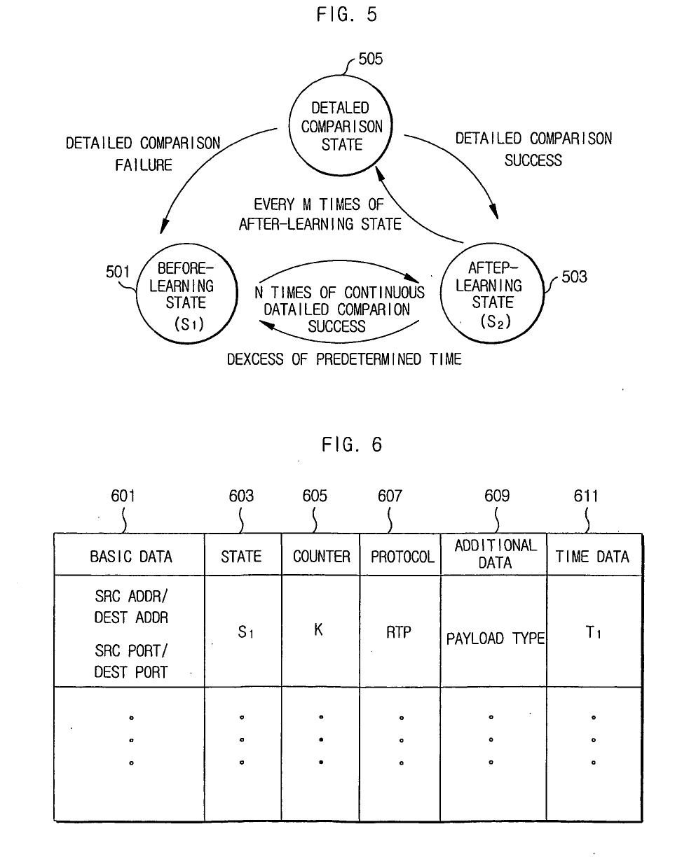

FIG. 5 illustrates the classification states of higher-layer protocols and the transition between each state in accordance with the preferred embodiment of the present invention.

Referring to FIG. 5, in order to classify higher-layer protocols, execute before-learning state (S1) 501 and after-learning state (S2) 503 determinations. FIG. 5 shows the case wherein a higher-layer protocol is classified when the arrival packet doesn't utilize a protocol related to the IP layer or a higher-layer protocol utilizing a well-known port. In the before-learning state (S1), it is determined that the content of all the fields of higher-layer protocol data headers 303 in higher-layer protocol data from the packets arrived at a device for distinguishing higher-layer protocols in accordance with the preferred embodiment of the present invention consistently corresponds to the content of all the fields of a target higher-layer protocol data header (hereinafter, referred to as ‘target protocol’). In another preferred embodiment of the present invention, it can be determined that the content of part of the essential fields of a higher-layer protocol data header 303 consistently corresponds to the content of the corresponding fields of a target protocol. Each case is discussed later in detail. Herein the device for distinguishing a higher-layer protocol can be an additional device such as a computer, which is installed in or coupled to an Internet access device such as a router. Moreover, the target protocol can be selected and stored in advance and then can be abstracted and utilized in order to maintain the accuracy of the comparison, a specific connection corresponding to the arrival packets, if successful comparisons to the target packet are continuously repeated the fixed times (N), then can transition to the after-learning state (S2) 503. The result of the comparison in the before-learning state (S2) 503 is registered in an administration table in FIG. 6.

The after-learning state (S2) 503 is a state of classifying protocols registered in the administration table by utilizing fixed data (especially, basic data) identifying the specific connection corresponding to the packet registered in the before-learning state (S1) 503. In order to improve the accuracy of the comparison, whenever the after-learning state (S2) 503 is repeated a fixed number of times (M), the detailed comparison can be executed. Each case is discussed later.

FIG. 6 shows the administration table in accordance with the preferred embodiment of the present invention.

Referring to FIG. 6, the administration table is composed of a basic data field 601, a state field 603, a counter field 605, a protocol field 607, an additional data field 609 and a time field 611. While connections are maintained between each host on the Internet, the IP address, the transport-layer protocol being used, and the contents of a source port field and a destination field in the transport-layer protocol data header, corresponding to the connection, are not changed. The administration table operates utilizing this characteristic: the basic data 601 in the administration table is utilized for determining whether or not the packet arriving at a device (used for distinguishing a higher-layer protocol) corresponds to the connection that is under the management of the administration table. As aforementioned, the source IP address, the destination IP address, the source port number and the destination port number can be used to comprise the basic data 601, which is not changed while a connection is maintained between each host on the Internet.

The state field 603 in the administration table represents the state of the connection corresponding to the above-mentioned basic data 601. More particularly, S1 represents the before-learning state and S2 represents the after-learning state.

The counter field 605 represents the number of successful comparisons (k) that arise from the process corresponding to the state field 603. Herein N is a predetermined number of executed comparisons made during the process corresponding to the state field 603. That is, if the number of successful comparisons (k) is more than the predetermined number (N), a transition is made to the next state.

The protocol field 607 is for registering the higher-layer protocol of the arrival packet (determined through the above-mentioned comparison process), which may, for example, be the higher-layer protocol RTP (real-time transfer protocol).

The additional data field 609 represents the data that must be registered in addition to the corresponding protocol. The additional data field 609 is an optional field depending on the protocol being used. For example, when the higher-layer protocol 607 being used is RTP, whether voice traffic or image traffic is being transferred can be known by checking the PTYPE field in the RTP header. The PTYPE (payload type) field in RTP header represents by what method the transmitted data was generated. For example, if the number in the PTYPE field is 18, it means that the transmitted data was voice data and was generated by G.729. Accordingly, the additional data field stores information about these protocols, making it possible to classify traffic in more detail.

The time field 611 stores time data necessary for determining whether or not the generated data is related to the Internet application.

While connections are being maintained between hosts on the Internet, for example, while host A and host B exchange a packet utilizing RTP, the basic data and the protocol are not changed. In the case wherein the protocol requires additional data, the additional data is registered in the administration table and the additional data is not changed for the duration of the connection. In the case wherein additional data is required, data type information is comprised of the protocol used and the additional data. Also, traffic connection information is comprised of basic data, protocol used and additional data for that one connection.

Referring to FIG. 5 again, if N is the number of continuous comparisons in detail that were executed successfully in a before-learning state (S1) 501, transition to an after-learning state (S2) 503, and then if M is the number of after-learning states (S2) 503 that were executed, transition to a detailed-comparison state 505. If the comparison process is successfully executed in the detailed-comparison state 505, then it is transitioned to an after-learning state (S2) 503 again, and if failed, it is then transitioned to a before-learning state (S1) 501. Also, if there is an elapsed time in the after-learning state (S2) 503 that exceeds a predetermined time, then transition to a before-learning state (S1) 501 occurs in order to maintain the accuracy of comparison.

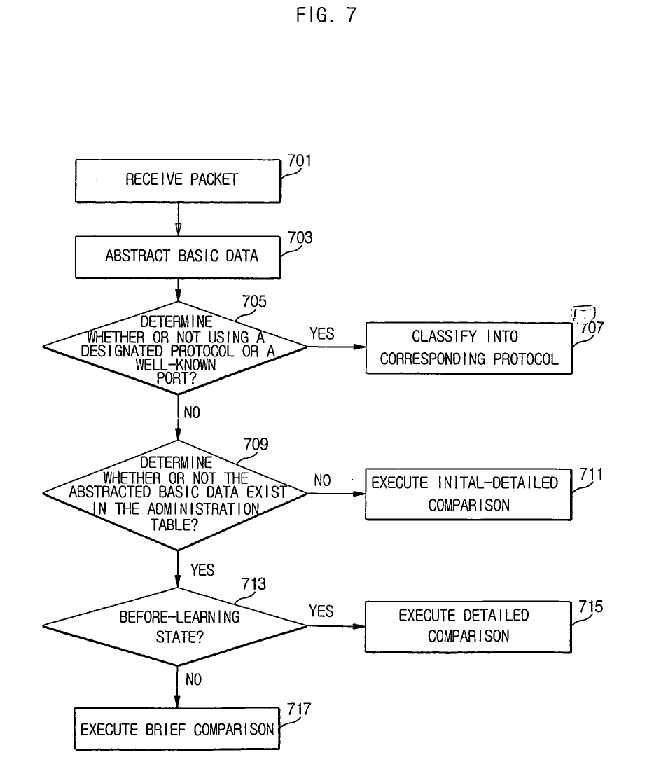

FIG. 7 is a flowchart illustrating the classification process of the higher-layer protocols in accordance with the preferred embodiment of the present invention.

Referring to FIG. 7, at step 701, when a packet arrives via the Internet, the device for distinguishing higher-layer protocols receives the packet. At step 703, the device for distinguishing higher-layer protocols abstracts the basic data, which is comprised of source and destination IP addresses and/or an identifier from the IP-layer datagram header and/or source and destination port numbers from the transport-layer protocol data header.

At step 705, by utilizing the abstracted basic data, the device determines whether a specially predetermined protocol related to the IP layer is present, such as ICMP, IGMP, routing protocol, or a protocol utilizing a well-known port. According to the result of the determination at step 705, the case is shown wherein the predetermined protocol related to the IP layer or the protocol utilizing a well-known port is, in fact, present and so then the process proceeds to step 707 and alternatively proceeds to step 709.

At step 707, according to the analysis made by utilizing the basic data, the case is shown wherein the predetermined protocol is related to the IP layer or does utilizing a well-known port, and so the protocol in the arriving packet is classified into one of the above-mentioned protocols.

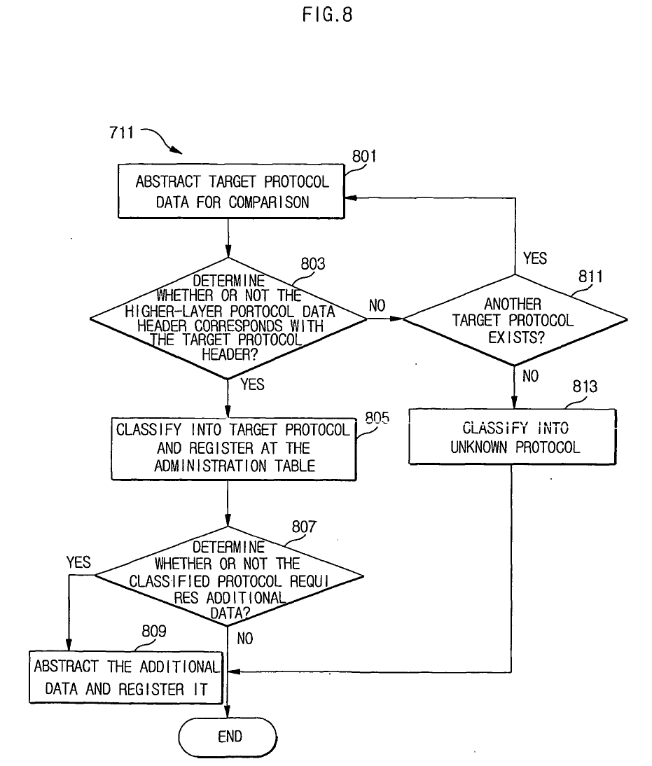

At step 709, it is determined whether or not the abstracted basic data is comprised of a plurality of basic data existing in the fields within the administration table. According to the result of the determination, if the abstracted basic data exists in the administration table, then proceed to step 713 and otherwise proceed to step 711. An initial-detailed comparison is executed at step 711 and it will be discussed later in conjunction with FIG. 8.

At step 713, if the abstracted basic data exists in the administration table, it is then determined whether or not the present state is a before-learning state for the arrival packet. If that is, in fact, the case of the arrival packet, proceed to step 715 and otherwise proceed to step 717.

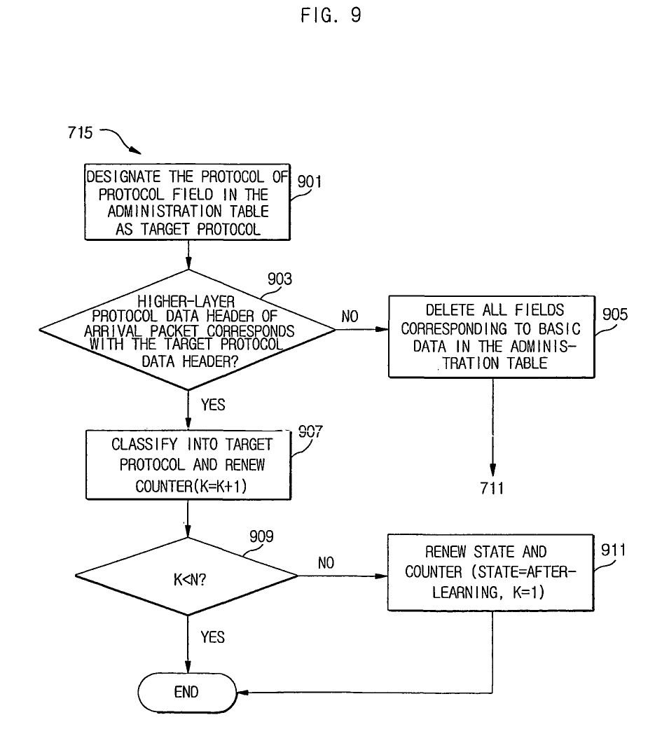

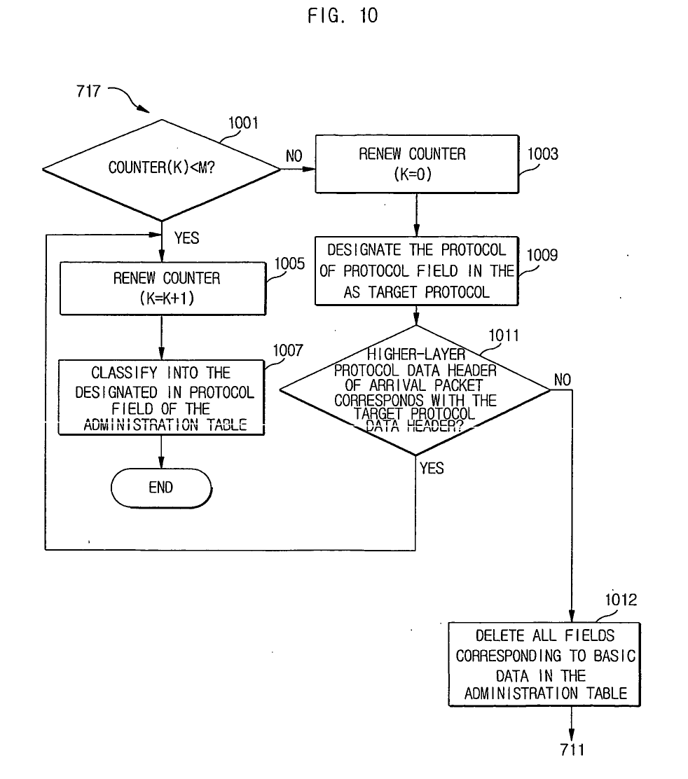

The detailed comparison process at step 715 will be discussed in conjunction with FIG. 9 and the brief comparison process will be discussed in conjunction with FIG. 10.

FIG. 8 is a flowchart illustrating the initial-detailed comparison process of the higher-layer protocols of arrival packets in accordance with the preferred embodiment of the present invention.

Referring to FIG. 8, at step 801 after step 711, the device used for distinguishing a higher-layer protocol abstracts the predetermined target protocol to be compared with the higher-layer protocol of the arrival packet. It is preferred to determine and store the target protocol along with some fields required to distinguish the target protocol in advance. And it is also preferred to determine various target protocols for monitoring higher-layer protocols transmitted via Internet.

At step 803, it is determined whether or not the higher-layer protocol data header of the arrival packet corresponds to the target protocol header. According to the result of the determination, if the higher-layer protocol data header of the arrival packet corresponds to the target protocol header, then proceed to step 805 and otherwise proceed to step 811. The method used to determine the correspondence can vary according to the various protocols employed. For example, when making a comparison, the contents of all the fields in the higher-layer protocol header of the arrival packet can be compared with contents of all the fields in the target protocol. Preferably, according to the type of the protocol, the contents of only several essential fields in the arrival packet and the target protocol can be compared for the purpose of reducing the resource load of the comparison process. Accordingly, a user can manually configure the device for distinguishing a higher-layer protocol to compare the contents of all the fields or of only several fields. Preferably, the device for distinguishing a higher-layer protocol can be configured for each type of protocol. When the result of the comparison is examined, the findings may reveal that all of the contents of all of the compared fields correspond to each other, but alternatively, it may be revealed that the contents of each field have a consist pattern, so it is also possible to check this consistency. The case wherein the contents of each field have a consistent pattern is referred to as a correspondence with consistency. For example, RTP header is comprised of VER, P, X, CC, M, PTYPE, SEQUENCE, NUM, TIME STAMP, SS1, CS1 and data field. In this case, the VER field represents the version of RTP and at the present time, is given as 2. So, if the value of the VER field is more than 2, it means that the protocol is not RTP. Also, the PTYPE (payload type) field represents the method by which the data is transmitted by RTP. In the case of PT-8, it means that the data is voice data compressed by G.729 and in this case, the length of the data field must be 10 bytes. In no-loss case, there is a difference of 1 between an early-arrived packet and the arrival packet in SEQUENCE NUM. As described above with examples, when some protocols are used, it is necessary not only to determine whether or a consistency between contents of each field exists, but also whether a correspondence with consistency exists between the contents of each field.

At step 805, the target protocol is classified and registered in the administration table. At this time, the counter (k) field is initialized at 1, the state field is changed to reflect the after-learning state and the time data is registered.

At step 807, it is determined whether the classified protocol is or is not a protocol requiring additional data. Because the protocol requiring the additional data is the same as described above, we omit the description. According to the result of determination made in step 807, the protocol does require additional data, so proceed to step 809 and if it were otherwise, terminate the process.

At step 809, necessary or predetermined additional data is abstracted and registered in the administration table.

According to the result of the determination made in step 803, at step 811, if the contents of the higher-layer protocol data header of the arrival packet do not correspond with the contents of the target protocol header, it is then determined whether or not other protocols exists. That is, step 811 can be a step for searching by various methods such as successively finding a target protocol that corresponds to the contents of the higher-layer protocol data header of the arrival packet. According to the result of the determination made in step 811, if other target protocols exists, return to step 801 and, if no target protocol exists that corresponds to the contents of the higher-layer protocol data header of the arrival packet, classify the higher-layer protocol of the arrival packet as an unknown protocol and terminate the process.

FIG. 9 is a flowchart illustrating the detailed comparison process of higher-layer protocols of arrival packets in accordance with the preferred embodiment of the present invention.

Referring to FIG. 9, at step 901 after step 715, the device used for distinguishing a higher-layer protocol designates the protocol in the protocol field of the administration table as the target protocol. At step 903, it is compared in detail to determine whether or not all fields or several essential fields of the higher-layer protocols of the arrival packet and the target protocol header match or correspond with consistency. Because each description is the same as described above, we omit the descriptions.

According to the determination made in step 903, if the higher-layer protocol data header of the arrival packet corresponds to the target protocol header, proceed to step 907. Otherwise, all fields corresponding to the basic data in the administration table are deleted before returning to step 711.

At step 907, the higher-layer protocol of the arrival packet is classified as the protocol designated in the protocol field of the administration table, the counter (k) is increased by 1 and, if the renewed counter (k) is less than the predetermined N, then the process terminates. If not, at step 911, execute the process that changes the state, as first initialized, to an after-learning state and sets the counter (k) to 1, then the process is terminated.

FIG. 10 is a flowchart illustrating the brief comparison process between higher-layer protocols of arrival packets in accordance with the preferred embodiment of the present invention.

Referring to FIG. 10, at step 1001 after step 717, the device used for distinguishing a higher-layer protocol determines whether the counter (k) is less than the predetermined M or not and, if so, at step 1005, increases the counter (k) by 1. If not, at step 1003, set the counter (k) to 0 and then execute step 1009, see the similar step 901 in FIG. 9 and step 1011, and the similar step 903 in FIG. 9. In a case wherein an inconsistency arises from the determination made in step 1011, execute equal step with step 905 in FIG. 9. In a case wherein a consistency arises from the determination made in step 1011, proceed, to step 1005.

At step 1007, the arrival packet is analyzed and, if it corresponds with the protocol in the protocol field of the administration table, then the higher-layer protocol of the arrival packet is classified as that protocol. The remaining step is terminated after this step.

In the preferred embodiment of the present invention, the method for distinguishing higher-layer protocols can be applied to Internet phone services. That is, for the purpose of improving service quality, Internet phone service providers can know details about their transmission quality such as the state of their resource utilization, delay or delay variations over a specific Internet segment of voice traffic corresponding to their Internet phone service. For the purpose of transmitting voice traffic over an Internet phone service, RTP and RTCP are utilized at the higher-layer, however, these protocols are not designated to correspond to well-known ports. However, according to the method for distinguishing higher-layer protocols, Internet phone service providers can monitor the characteristics of packets by way of abstracting statistical data from packets that utilize RTT and RTCP as their higher-layer protocol and have field values commonly used in Internet phone applications or, in the case of Internet protocols that do not use RTT, but use other higher-layer protocols, by way of designating information for distinguishing these protocols, comparing arrival packets, distinguishing Internet phone protocols, and then abstracting statistical data.

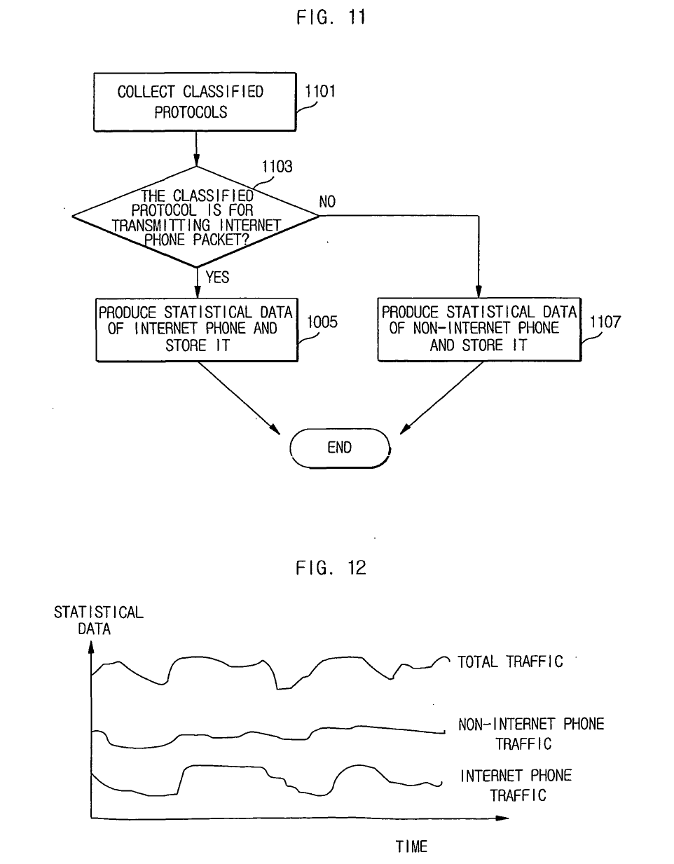

FIG. 11 is a flowchart illustrating the process of abstracting the statistical data about the traffic on an Internet phone service and non-internet phone traffic in accordance with the preferred embodiment of the present invention.

Step 1101 is a step for retrieving the data field of the higher-layer protocol as distinguished through the process in FIG. 7. Step 1103 is a step for determining whether the classified protocol corresponds to the protocol field for transmitting packets via Internet phone. In a case wherein a protocol for transmitting packets via Internet phone according to the result of the determination made in step 1105, the statistical data related to traffic for Internet phone is produced and stored as a preferred example or standard. If the classified protocol does not correspond to the protocol for transmitting packets via Internet phone, at step 1107, the statistical data related to traffic for non-Internet phone is produced and stored as a preferred example or standard. The data produced and stored at step 1105 and step 1107 can have a specific format and additionally follow a defined MIB format.

FIG. 12 shows the statistical characteristics acquired from the abstracting process in FIG. 11.

FIG. 12 shows an example wherein the statistical data is represented as a graph. The X-axis represents time or some other article and the Y-axis represents the produced value for the article of the X-axis. As a special example, FIG. 12 shows, with accompanying time, the characteristics of traffic transmitted via Internet phone and non-Internet phone. Said characteristics can be delay, the amount of network resource occupation, delay variation, a count of the number of arrival packets, a count of the number of packets lost, a count of erred packets, transmission ratio, and packet loss ratio. It is also possible to represent the statistical data in text format, differing from the method in FIG. 12. As shown in FIG. 12, by the use of the conventional method, representing total traffic was the only way to represent Internet traffic, however, by the use of the present invention, it is possible to classify total Internet traffic into various categories of applications and represent the classified traffic as that of Internet phone and that of non-Internet phone.

As described above, the device used for distinguishing a higher-layer protocol can be not only a standalone device, regardless of the Internet access device employed, such as a router, and having a computer program for distinguishing a higher-layer protocol within itself, but also a built-in device within a router. However, in the case of the built-in device, it may disrupt the functions of the router in which it is contained. The device for distinguishing a higher-layer protocol can produce the various types of protocols and the resource occupation ratio of each protocol by utilizing the statistical data abstracted from the aforementioned method used for distinguishing protocols. By using the statistical data, a network management system can manage a network efficiently and actively and perform such functions as bypassing a specific protocol. In greater detail, the device for distinguishing a higher-layer protocol according to the present invention can work together with a device executing RMON (remote monitoring). The RMON is a method for collecting and analyzing network traffic. Analyzed data is produced by the RMON and stored according to the predetermined MIB.

It is also possible to define a statistical field for statistical data in the conventional RMON MIB, wherein the statistical data is classified into the different types of services, for example voice or video, by distinguishing the higher-layer protocol according to the present invention. The statistical data collected by these monitoring procedures is stored in the database of the device for distinguishing a higher-layer protocol. Afterwards, when NMS (network management system) requests the statistical data from the device for the purpose of distinguishing a higher-layer protocol at a fixed interval (for example, every 3 minutes), the device for distinguishing a higher-layer protocol transmits the statistical data to the corresponding NMS. The requested field can be a certain field or all fields. A SNMP (simple network management protocol) or an original protocol used within the RMON or NMS can be utilized as a transmitting protocol for the statistical data. NMS operates a predetermined network management task using the received statistical data.

It is appreciated for those skilled in the art that the present invention is not departing from the aforementioned embodiments of the detailed description, the appended claims and the appended drawings and a plurality of modifications can be accomplished within the spirit and the scope of the present invention. Especially, it is also appreciated for those skilled in the art that data formats can be constructed by changing each field.

Inderatrial Applicability

As described in detail, according to the present invention, a method and device for distinguishing higher-layer protocols, wherein a method and device can distinguish the higher-layer protocols directly related to Internet applications and then analyze the traffic characteristics of various higher-layer applications such as commonly used Internet phone applications or popular network game applications, is provided.

According to the present invention, a method and device for distinguishing higher-layer protocols used to transmit Internet traffic, which method and device can efficiently manage Internet or network traffic by providing basic data about the extent to which each classified protocol, used in various multimedia applications, utilizes Internet or network resources and identifying their traffic characteristics, is provided.

According to the present invention, a method and device for distinguishing the higher-layer protocols of Internet traffic, which method and device can improve the accuracy of classifying higher-layer protocols and, by doing so, reduce the time required to classify these protocols, by maintaining the basic data content for the duration of each internet connection, thereby enabling detailed classification, requiring long periods of time, and lengthy calculations in classification process of the higher-layer protocols to be executed in a before-learning state, and finally a brief classification, using basic data, is executed in an after-learning state, is provided.

1. A method for distinguishing a higher-layer protocol of an arrival packet, wherein the higher layer is higher than the transport layer, the method comprising the steps of:
abstracting basic data from the arrival packet;
determining whether or not the abstracted basic data exists in a predetermined administration table;
abstracting a target protocol by selecting the target protocol corresponding to the higher-layer protocol of the arrival packet from a plurality of predetermined target protocols in the event that the abstracted basic data does not exist in the predetermined administration table;
registering the basic data and the abstracted target protocol in the predetermined administration table; and
renewing the administration table corresponding to the abstracted basic data in the event that the abstracted basic data exists in the predetermined administration table.

2. The method as stated in claim 1, wherein statistical data based on the classifying a plurality of arrival packets into categories of higher-layer protocols by utilizing said steps can be utilized to perform network tasks within a network management system.

3. The method as stated in claim 2, wherein a MIB (Management Information Base) for the statistical data on each higher-layer protocol is additionally defined or the statistical data on each higher-layer protocol conforms to a predetermined format.

4. The method as stated in claim 3, wherein the higher-layer protocols comprise at least one selected from a group consisting of RTP, RTCP and a nonstandard internet phone protocol used by each provider, and are utilized to distinguish Internet phone and non-internet phone traffic in order to obtain statistical data.

5. The method as stated in claim 4, wherein the statistical data on the traffic of Internet phone applications and the traffic of non-internet phone applications comprises at least one selected from a group consisting of time, protocol, source IP address, destination IP address and a pair of source IP address and destination IP address.

6. The method as stated in claim 5, wherein the statistical data on the traffic of Internet phone applications and the traffic of non-internet phone applications can be represented in graphic or text format.

7. The method as stated in claim 1, wherein the basic data comprises at least one field from a plurality of fields assigned to an IP datagram header or a transport-layer protocol header.

8. The method as stated in claim 1, wherein the plurality of the predetermined target protocols are a plurality of fields used for detailed comparison, wherein the plurality of fields is selected and stored in advance.

9. The method as stated in claim 1, further comprising:
classifying the protocol of the arrival packet as a reserved protocol or a protocol corresponding to a well-known port in the event that a reserved protocol is designated in a protocol field of the IP datagram header of the arrival packet or the well-known port is designated in a protocol field of the transport-layer protocol data header of the arrival packet.

10. The method as stated in claim 1, wherein the predetermined administration table is comprised of:
a basic data field for storing the basic data;
a protocol field for storing the protocol;
an additional data field for storing additional data;
a time data field for storing time data;
a state field for storing classifications of state, wherein the state is comprised of a before-learning state and an after-learning state;
a counter field for storing a number corresponding with the state field.

11. The method as stated in claim 1 or claim 10, further comprising:
registering the abstracted additional data in the predetermined administration table in the event that additional data is required for the target protocol.

12. The method as stated in claim 1, wherein the step of abstracting the target protocol by selecting the target protocol corresponding to the higher-layer protocol of the arrival packet from a plurality of predetermined target protocols in the event that the abstracted basic data does not exist in the predetermined administration table, is the step of abstracting the target protocol when content stored in a predetermined field of the target protocol's header matches or consistently corresponds to a content stored in a field of a higher-layer protocol data header of the corresponding arrival packet.

13. The method as stated in claim 12, wherein the predetermined field may be all fields or a part of essential fields used for distinguishing the target protocol.

14. The method as stated in claim 10, wherein the step of renewing the administration table corresponding to the abstracted basic data in the event that the abstracted basic data exists in the predetermined administration table comprises the steps of:
executing a detailed comparison in the event of the before-learning state; and
executing a brief comparison in the event of the after-learning state.

15. The method as stated in claim 14, wherein the step of executing a detailed comparison in the event of a before-learning state comprises the steps of:
designating a protocol in the protocol field of the predetermined administration table as the target protocol;
determining whether or not the higher-layer protocol data header of the arrival packet corresponds to the designated target protocol header;
classifying the arrival packet as the designated target protocol, increasing the number in the counter field by 1 and then renewing the state to an after-learning state and the counter field to its initial value wherein the increased number is not less than a first positive integer N in the event of a correspondence arising from the determination;
deleting all the fields corresponding to the basic data in the predetermined administration table in the event of a discordance arising from the determination.

16. The method as stated in claim 15, wherein the step of determining whether or not the higher-layer protocol data header of the arrival packet corresponds to the designated target protocol header is the step of determining whether or not content stored in the predetermined field of the target protocol's header consists with or consistently corresponds to content stored in a field of the higher-layer protocol data header of the corresponding arrival packet.

17. The method as stated in claim 16, wherein the predetermined field may be all fields or a part of essential fields used for distinguishing the target protocol.

18. The method as stated in claim 14, wherein the step of executing a brief comparison in the event of an after-learning state comprises the steps of:
determining whether or not the abstracted basic data corresponds to the basic data stored in the basic data field of the predetermined administration table;
determining whether or not a number in the counter field corresponding to the abstracted basic data is less than a second positive integer M in the event of correspondence arising from the determination;
classifying the arrival packet as the protocol designated in the protocol field of the predetermined administration table and then increasing the number in the counter field by 1 in the event that the number in the counter field is less than the second positive integer M according to the correspondence or discordance arising from the determination;
initializing the counter field and then comparing in detail, in the event that the number in the counter field is not less than the second positive integer M according to the correspondence or discordance arising from the determination;
initializing the counter field and then executing an initial-detailed comparison in the event of discordance according to the correspondence or discordance arising from the determination.

19. The method as stated in claim 1 or claim 3, wherein the statistical data comprises at least one selected from a group consisting of a count of the number of arrival packets, a delay, a delay variation, a count of the number of packets lost, a packet loss ratio, a count of erred packets, a ratio of erred packets, and a transmission ratio, wherein the statistical data is produced from the arrival packets and from a plurality of previously-arrived packets having the same classified protocol corresponding to the arrival packet or the plurality of previously-arrived packets and having the same basic data corresponding to the arrival packet wherein the plurality of previously-arrived packets arrived earlier than the arrival packet.

20. The method as stated in claim 19, wherein the statistical data is produced to relate to at least one selected from a group consisting of a source IP address, a destination IP address, a source port number, a destination port number and the protocol field.

21. A method for distinguishing the data type of a higher-layer protocol header, wherein the higher layer is higher than the transport layer, the method comprising the steps of:
abstracting basic data from the arrival packet;
determining whether or not the abstracted basic data exists in a predetermined administration table;
abstracting the data type by selecting the target protocol corresponding to the higher-layer protocol of the arrival packet from a plurality of predetermined target protocols, wherein the data type is comprised of protocol and additional data in the event that the abstracted basic data does not exist in the predetermined administration table;
registering the basic data and the abstracted data type in the predetermined administration table; and
renewing the administration table corresponding to the abstracted basic data in the event that the abstracted basic data exists in the predetermined administration table.

22. The method as stated in claim 21, wherein statistical data based on the classification of each of the plurality of arrival packets into higher-layer data types by the use of said steps, can be utilized in a network management system to manage the network.

23. The method as stated in claim 22, wherein an MIB used for statistical data on each higher-layer data type is additionally defined or the statistical data on each higher-layer protocol conforms to a predetermined format.

24. The method as stated in claim 23, wherein the higher-layer protocols comprise at least one selected from a group consisting of RTP, RTCP and a nonstandard internet phone protocol used by each provider, and are utilized to distinguishing Internet phone and non-Internet phone traffic in order to obtain statistical data.

25. The method as stated in claim 24, wherein the statistical data on the traffic of Internet phone applications and the traffic of non-internet phone applications is represented as at least one selected from a group consisting of time, data type, source IP address, destination IP address and a pair of source IP address and destination IP address.

26. The method as stated in claim 25, wherein the statistical data on the traffic of Internet phone applications and the traffic of non-Internet phone applications can be represented in graphic or text format.

27. The method as stated in claim 21, wherein the basic data is comprised of at least one field from a plurality of fields assigned to an IP datagram header or a transport-layer protocol header.

28. The method as stated in claim 21, wherein the plurality of the predetermined target protocols are a plurality of fields used for making detailed comparisons, wherein the plurality of fields are selected and stored in advance.

29. The method as stated in claim 21, further comprising:
in the event that a reserved protocol is designated in a protocol field of the IP datagram header of the arrival packet or the number of a well-known port is designated in a protocol field of the transport-layer protocol data header of arrival packet, classifying the protocol of the arrival packet as the reserved protocol or the data type corresponding to the well-known port.

30. The method as stated in claim 21, wherein the predetermined administration table is comprised of:
a basic data field for storing basic data;
a protocol field for storing protocols;
an additional data field for storing additional data;
a time data field for storing time data;
a state field for storing classifications of states, wherein the state is comprised of a before-learning state and an after-learning state;
a counter field for storing a number corresponding to the state field.

31. The method as stated in claim 21, wherein the step of abstracting a data type by selecting the target protocol corresponding to the higher-layer protocol of the arrival packet from a plurality of predetermined target protocols in the event that the abstracted basic data does not exist in the predetermined administration table is the step of abstracting the data type when content stored in a predetermined field of the target protocol's header consists with or consistently corresponds to content stored in a field of the higher-layer protocol data header of the corresponding arrival packet.

32. The method as stated in claim 31, wherein the predetermined field may be all fields or a part of essential fields used for distinguishing the target protocol.

33. The method as stated in claim 32, wherein the step of renewing the administration table corresponding to the abstracted basic data in the event that the abstracted basic data exists in the predetermined administration table comprises the steps of:
in the event of the before-learning state, executing a detailed comparison; and
in the event of the after-learning state, executing a brief comparison.

34. The method as stated in claim 33, wherein the step of executing a detailed comparison in the event of the before-learning state comprises the steps of:
designating a protocol in the protocol field and a protocol corresponding to the additional data in the additional data field of the predetermined administration table as the target protocol;
determining whether or not the higher-layer protocol data header of the arrival packet corresponds to the designated target protocol header;
classifying the arrival packet as the designated data type, increasing a number in the counter field by 1 and then renewing the state to the after-learning state and the counter field to its initial value wherein the increased number is not less than a first positive integer N in the event of correspondence arising from the determination;
deleting all fields corresponding to the basic data in the predetermined administration table in the event of discordance arising from the determination.

35. The method as stated in claim 34, wherein the step of determining whether or not the higher-layer protocol data header of the arrival packet corresponds to the designated target protocol header is the step of determining whether or not content stored in the predetermined field of the target protocol's header consists with or consistently corresponds to content stored in a field of the higher-layer protocol data header of the corresponding arrival packet.

36. The method as stated in claim 35, wherein the predetermined field may be all fields or a part of essential fields used for distinguishing the target protocol.

37. The method as stated in claim 33, wherein the step of executing a brief comparison in the event of the after-learning state comprises the steps of:
determining whether or not the abstracted basic data corresponds to the basic data stored in the basic data field of the predetermined administration table;
determining whether or not a number in the counter field corresponding to the abstracted basic data is less than a second positive integer M in the event of correspondence arising from the determination;
classifying the higher-layer data type into the data type designated in the predetermined administration table and then increasing the number in the counter field by 1 in the event that the number in the counter field is less than the second positive integer M according to the correspondence or discordance arising from the determination;
initializing the counter field and then comparing in detail in the event that the number in the counter field is not less than the second positive integer M according to the correspondence or discordance arising from the determination;
initializing the counter field and then executing an initial detail comparison in the event of discordance arising from the determination.

38. The method as stated in claim 21 or claim 23, wherein the statistical data comprises at least one selected from a group consisting of a count of the number of arrival packets, a delay, a delay variation, a count of the number of packets lost, a packet loss ratio, a count of erred packets, an erred packet ratio, and a transmission ratio, wherein the statistical data is produced from the arrival packets and from a plurality of previously-arrived packets having the same classified protocol corresponding to the arrival packet or the plurality of previously-arrived packets having the same basic data corresponding to the arrival packet and wherein the plurality of previously-arrived packets arrived earlier than the arrival packet.

39. The method as stated in claim 38, wherein the statistical data is produced to correspond to at least one selected from a group consisting of a source IP address, a destination IP address, a source port number, a destination port number and the protocol field.

40. A device for distinguishing the higher-layer protocol of an arrival packet, wherein the higher layer is higher than the transport layer, comprising:
means for abstracting basic data from an arrival packet;
means for determining whether or not abstracted basic data exists in a predetermined administration table;
means for abstracting a target protocol by selecting the target protocol corresponding to the higher-layer protocol of the arrival packet from a plurality of predetermined target protocols when the abstracted basic data does not exist in the predetermined administration table;
means for registering the basic data and the abstracted target protocol in the predetermined administration table; and
means for renewing the administration table corresponding to the abstracted basic data when the abstracted basic data does exist in the predetermined administration table.

41. A device for distinguishing the data type of a higher-layer protocol header, wherein the higher layer is higher than the transport layer, comprising:
means for abstracting basic data from an arrival packet;
means for determining whether or not the abstracted basic data exists in a predetermined administration table;
means for abstracting the data type by selecting the target protocol corresponding to the higher-layer protocol of the arrival packet from a plurality of predetermined target protocols when the abstracted basic data does not exist in the predetermined administration table, wherein the data type is comprised of the protocol and the additional data;
means for registering the basic data and the abstracted data type in the predetermined administration table; and
means for renewing the administration table corresponding to the abstracted basic data when the abstracted basic data does exist in the predetermined administration table.

42. A system for distinguishing the higher-layer protocol of an arrival packet, wherein the higher layer is higher than the transport layer, comprising:
a storage device for storing a program; and
a processor coupled to the storage device for executing the program, wherein the processor operates with the program to abstract basic data from the arrival packets;
determine whether or not the abstracted basic data exists in a predetermined administration table;
abstract a target protocol by selecting the target protocol corresponding to the higher-layer protocol of the arrival packet from a plurality of predetermined target protocols in the event that the abstracted basic data does not exist in the predetermined administration table;
register the basic data and the abstracted target protocol in the predetermined administration table; and
renew the administration table corresponding to the abstracted basic data in the event that the abstracted basic data does exist in the predetermined administration table.

43. A system for distinguishing a the data type of a higher-layer protocol header, wherein the higher layer is higher than the transport layer, comprising:
a storage device for storing a program; and
a processor coupled to the storage device for executing the program,
wherein the processor operates with the program to
abstract basic data from the arrival packets;
determine whether or not the abstracted basic data exists in a predetermined administration table;
abstract the data type by selecting the target protocol corresponding to the higher-layer protocol of the arrival packet from a plurality of predetermined target protocols, wherein the data type is comprised of a protocol and additional data in the event that the abstracted basic data does not exist in the predetermined administration table;
register the basic data and the abstracted data type in the predetermined administration table; and
renew the administration table corresponding to the abstracted basic data in the event that the abstracted basic data does exist in the predetermined administration table.
